(19) United States
(12) Patent Application Publication
(10) Pub. No.: US 2025/0217745 A1
(43) Pub. Date: Jul. 3, 2025

(54) SYSTEMS AND METHODS FOR RECOMMENDING RULES FOR ROUTING CALLS

(71) Applicant: Talkdesk, Inc., San Francisco, CA (US)

(72) Inventors: António Veloso, Lisbon (PT); Alexandre Pinheiro, Lisbon (PT)

(21) Appl. No.: 19/083,221

(22) Filed: Mar. 18, 2025

Related U.S. Application Data
(63) Continuation of application No. 16/666,496, filed on Oct. 29, 2019, now Pat. No. 12,271,848.

(51) Int. Cl. G06Q 10/0633; G06F 16/909; G06Q 10/0631; G06Q 10/0639; G06Q 10/1093; G06Q 30/016; H04M 3/436; H04M 3/51; H04M 3/523

(52) U.S. Cl. CPC G06Q 10/0633; G06F 16/909; G06Q 10/06312; G06Q 10/06393; G06Q 10/1097; G06Q 30/016; H04M 3/4365; H04M 3/5183; H04M 3/5232; H04M 3/5233

(57) ABSTRACT

In one embodiment, an entity such as a company may desire to use agents associated with a contact center to handle calls for the company. The company may identify customer categories for the calls such as technical support and billing. Rather than have the company create the rules that are used to select agents to handle calls for each category, the contact center may use historical call data, such as performance metrics and customer satisfaction survey information, to recommend rules to the company for each category. The recommended rules may also be based on the specific industry, field, or sector associated with the company.

### BACKGROUND

In a contact center calls are received and routed to available agents. One common way to route calls to agents, is to place agents in different queues that each correspond to a different call topic or subject matter. For example, agents that that are to handle technical support calls may be placed in the technical support queue and agents that are to handle billing questions may be placed in the billing queue. When a call is received with a billing question the next agent in the billing queue is selected to handle the call.

However, there are drawbacks associated with this approach. In particular, using agent queues may result in an inefficient use of agent resources. For example, a contact center may receive many billing related calls and therefore the billing queue may be full. However, there may be many agents in the technical support queue who would be able to handle the calls, but because they are not in the billing queue they are idle.

### SUMMARY

In one embodiment, an entity such as a company may desire to use agents associated with a contact center to handle calls for the company. The company may identify customer categories for the calls such as technical support and billing. Rather than have the company create the rules that are used to select agents to handle calls for each category, the contact center may use historical call data, such as historical performance metrics and historical customer satisfaction survey information, to recommend rules to the company for each customer category. The recommended rules may also be based on the specific industry, field, or sector associated with the company.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example system architecture;

FIG. 2 is an illustration of an example agent routing platform;

FIG. 3 is an illustration of an example method for recommending rules for routing calls to agents for a plurality of customer categories;

FIG. 4 is an illustration of an example method for recommending a rule for routing calls to agents; and

FIG. 5 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

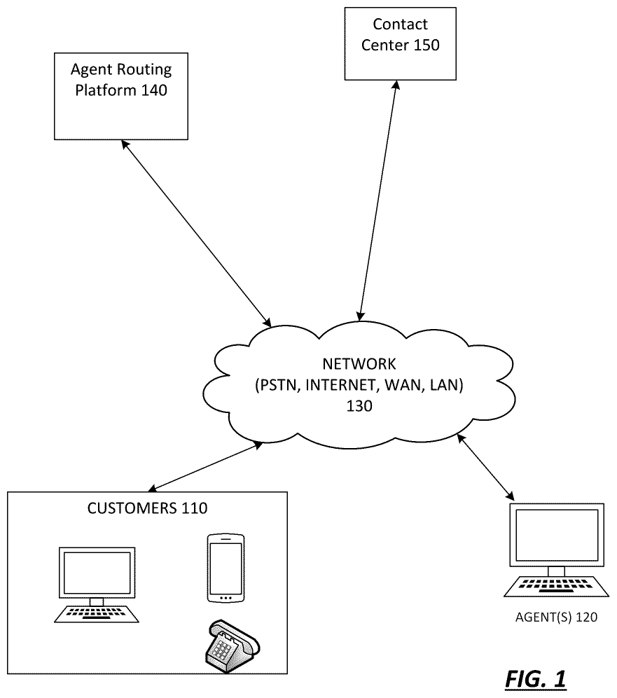

FIG. 1 is an example system architecture 100, and illustrates example components, functional capabilities and optional modules that may be included in a cloud-based contact center infrastructure solution. Customers 110 interact with a contact center 150 using voice, email, text, and web interfaces in order to communicate with agent(s) 120 through a network 130 and one or more of text or multimedia channels. The agent(s) 120 may be remote from the contact center 150 and handle communications with customers 110 on behalf of an enterprise. The agent(s) 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

Agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. A smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers to interact with them by speaking instead of pushing buttons on their phones. IVR applications may be used to collect data, schedule callbacks and transfer calls to live agents. IVA systems are more advanced and utilize artificial intelligence (AI), machine learning (ML), advanced speech technologies (e.g., natural language understanding (NLU)/natural language processing (NLP)/natural language generation (NLG)) to simulate live and unstructured cognitive conversations for voice, text and digital interactions. In yet another example, Social media, email, SMS/MMS, IM may communicate with their counterpart's application (not shown) within the contact center 150.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from reporting/dashboard information and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent and contact center performance. Unified messaging (UM) applications include various messaging and communications media (voicemail, email, SMS, fax, video, etc.) stored in a common repository and accessed by users via multiple devices through a single unified interface.

In order to improve the routing of calls to agents 120, the calls (or other communications) received by the contact center 150 may be routed to agents 120 by an agent routing platform 140. While shown in FIG. 1 as separate from the contact center 150, depending on the embodiment the agent routing platform 140 may be part of the contact center 150.

The agent routing platform 140 may route calls to agents 120 based on attributes associated with each agent 120, and one or more rules. As used herein an attribute may be a skill or characteristic associated with an agent 120. Examples of attributes may include language attributes (e.g., what languages that the agent speaks), work-related attributes (e.g., the agent 120 is trained to answer calls related to technical support, or billing, returns, shipping, etc.), and attributes representing any accolades or achievements that the agent 120 may have received (e.g., has the agent 120 been rewarded for providing excellent service). In some embodiments, each attribute may be associated with a proficiency score.

A rule for routing a call may specify a plurality of required attributes and may provide a minimum proficiency score for one or more of the specified attributes. For example, a sample rule may specify that an agent 120 have an attribute of “technical support” and an attribute of “speaks Chinese” with a proficiency level greater than or equal to four. A call associated with such a rule may only be routed to an agent 120 that has the attribute “technical support” and speaks Chinese with a proficiency level that is greater than or equal to four.

In some embodiments, the agent routing platform 140 may associate rules with customer categories and may route calls according to the customer category associated with a call or customer. Examples of customer categories may include the language spoken by a customer, the country associated with a customer, the type of service requested by the customer (e.g., tech support or billing), and a priority associated with the customer (e.g., is the customer a VIP?).

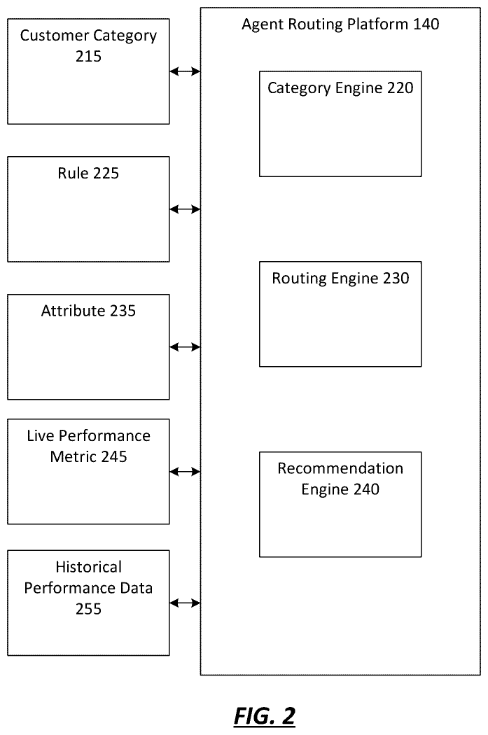

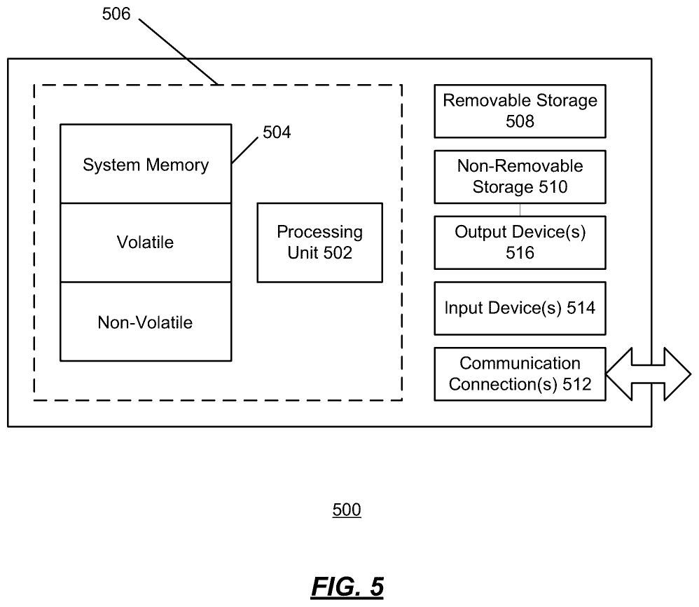

FIG. 2 is an illustration of an example agent routing platform 140. As shown the agent routing platform 140 includes various modules including a category engine 220, a routing engine 230, and a recommendation engine 240. More or fewer modules may be supported by the agent routing platform 140. Depending on the embodiment, each of the agent routing platform 140, category engine 220, routing engine 230, and recommendation engine 240 may be implemented together or separately by one or more general purpose computing devices such as the computing system 500 illustrated with respect to FIG. 5.

The category engine 220 may receive calls from customers 110 for a particular entity or company and may associate the call with a customer category 215. As used herein a customer category may be a set of characteristics that are associated with a customer 110 of a call. The characteristics may include country of origin (i.e., what country is the call coming from), language (i.e., what language is spoken by the customer 110), call topic or purpose (i.e., what type of help is the customer seeking), and customer priority 110 (e.g., is the customer a VIP or does the customer pay for support). Other types of characteristics may be supported.

Depending on the embodiment, the customer engine 220 may determine the customer category for a call using call information indicating the country of origin associated with the call and other call routing information provided by the contact center 150. The category engine 220 may further determine the customer category using IVR information associated with the call. For example, the customer may have selected an option indicating the language that they speak (e.g., English or Spanish) and the type of information that they are seeking (e.g., tech support vs. billing). Depending on the embodiment, the received call may include a customer number or identifier provided by the contact center 150 that may be used to determine the priority or VIP status of the caller and/or the customer category.

The routing engine 230 may, for each customer category 215, route calls associated with the customer category 215 to one or more agents 120 based on one or more rules 225 associated with the customer category 215 and one or more attributes associated with each agent 120. The routing engine 230 may select a call for a customer category 215 and may retrieve one or more rules 225 associated with the customer category 215. The routing engine 230 may retrieve the one or more rules 225 from a rule storage associated with the agent routing platform 140 and/or the contact center 150. Depending on the embodiment, if no rules 225 are associated with the customer category, the routing engine 230 may route the call to any available agent 120. Alternatively, the routing engine 230 may select an agent 120 using a default or catchall rule 225. The default rule 225 may be set by a user or administrator, for example.

After retrieving the rules 225, the routing engine 230 may determine agents 120 that have attributes 235 that satisfy the rules 225. The routing engine 230 may retrieve the attributes 235 associated with each available agent 120 (i.e., an agent 120 that is not currently on a call or otherwise unavailable) and may determine available agents 120 that satisfy the rules 225. The routing engine 130 may then route the call to one of the determined agents 120.

The routing engine 230 may continuously select calls and may route the selected calls to agents 120 that have attributes 235 that satisfy the rules 225 associated with the categories 215. In some implementations, each category 215 may have an instance of the routing engine 230 that routes calls to agents 120 based on the rules 225 associated with that category 215.

The recommendation engine 240 may monitor one or more performance metrics 245 associated with each customer category 215 or the entire contact center 150. A performance metric 245 may be any metric that can be used to measure the performance or overall success of routing calls to agents 120 and/or maintaining call quality. Example performance metrics 245 may include average handling time (i.e., the average amount of time that it takes for a received call to be completed by an agent 120), average wait time (i.e., the average amount of time that a call waits to be received by an agent 120), service level, abandon rate (i.e., the number of calls that are abandoned before they are handled by an agent 120), and average customer satisfaction (i.e., an average based on responses to customer satisfaction surveys). Other performance metrics 245 may be supported.

In some embodiments, the performance metrics 245 may be based on a computer analysis of the calls between the customers 110 and the agents 120. For example, a model trained on a variety of previous agent 120 and customer 110 calls (e.g., trained using the audio data or transcripts of the calls) may generate scores or ratings for each call of the customer category 215 after it is handled by an agent 120.

In some embodiments, the recommendation engine 240 may use the performance metrics 145 to generate historical performance data 255. The historical performance data 255 may include data collected about each category 215 or entity over time including, but not limited to, the number of calls associated with the category 215, the agents 120 that handled calls for the category 215 including their associated attributes 235 and proficiency levels, rules 225 used to route calls for the category 215, and the various performance metrics 245 that were observed for the category 215. The performance metrics 245 may include performance metrics 245 related to the performance of calls associated with the category 215 (e.g., average hold time and abandonment rate) and performance metrics 245 related to the agents 120 that handled calls for the category 215 (e.g., customer satisfaction surveys).

Depending on the embodiment, the historical performance data 255 may be used to train a model that can predict the performance metrics 245 based on criteria such as the available agents 120 and associated attributes 235, the rules 225, a sector or business, and a current call volume received by the contact center 150, for example.

The recommendation engine 240 may further be configured to recommend rules 225 to associate with a customer category 215 based on historical performance data 225. For example, an entity, such as a corporation or company, may begin using the contact center 150 to handle calls for the entity. The entity may desire to have customer categories 215 corresponding to different business divisions (e.g., technical support and billing), different languages, and different counties of origin. The entity may further desire to have customer categories 215 corresponding to different languages or countries of its customers 110.

After the entity creates or selects its customer categories 215, the recommendation engine 240 may use the historical performance data 255 to recommend, for each customer category 215, a rule 225 that may be used by the entity to select agents 120 to handle calls associated with the customer category. As described above, the historical performance data 255 may include the rules 225 (including attributes 235 and proficiency levels) used for various customer categories 215 of the contact center 150 as well as the measured performance metrics 245 for the customer categories 215 over time.

In some implementations, the recommendation engine 240, when determining a rule 225 to recommend for a customer category, may consider the historical performance data 255 associated with similar customer categories. In addition, the recommendation engine 240 may determine the sector (e.g., business type or industry) associated with the entity. The recommendation engine 240 may then consider the historical performance data 255 associated with customer categories 215 that are associated with other entities in the same general sector.

In some implementations, the recommendation engine 240 may use the model trained using the historical performance data 245 to recommend a rule 225 for each customer category 215 proposed by the entity. The model may be used to predict the performance metrics 235 for a category 215, and associated rules 225, based on factors such as the sector associated with the entity, and the number of agents 120 assigned to the contact center 150. The recommendation engine 240 may then recommend a rule 255 for a customer category 215 that has the highest predicted performance metrics 235 for the customer category 215 and sector.

For example, when an entity determines to use a contact center 150 to handle calls for the entity, the recommendation engine 240 may present an administrator associated with the entity with a GUI through which the administrator may create customer categories. Depending on the embodiment, the recommendation engine 240 may initially recommend customer categories 215 based on the customer categories 215 used by other entities in the same or similar sector. Thus, if the entity is a clothing retailer, the recommendation engine 240 may recommend similar customer categories 215 as used by other entities that are also retailers.

After selecting one or more of the customer categories in the GUI (or after creating their own customer categories), the recommendation engine 240 may use the model and/or the historical performance data 255 to recommend a rule 225 for each of the customer categories 215. Continuing the above example, where the entity is a retailer and the customer categories are “returns” and “orders”, the recommendation engine 240 may retrieve historical performance data 255 associated other retail entities and customer categories that are similar to “returns” and “orders”. The recommendation engine 240 may then use the historical performance data 255 to determine rules 225, and combinations of attributes 235, that were associated with high performance metrics 245 for customer categories similar to “returns” and “orders”.

The recommendation engine 240 may present the determined rule 255 for each customer category 215 to the administrator in the GUI. Each determined rule 255 may be presented with its associated attributes 235 and predicted performance metrics 245. The administrator may then accept each of the presented rules 225 or may modify the attributes 235 of a recommended rule 225 using tools provided in the GUI. If the administrator changes an attribute 235 of a rule 225, the recommendation engine 240 may display re-predicted performance metrics 245 for the rule 225 based on the changed attribute 235. The administrator may then use the GUI to associate the presented, or modified, rules 225 with the customer category 215. The agent routing platform 140 may then begin routing calls to agents 120 for the entity based on the rules 225 associated with the customer categories 215.

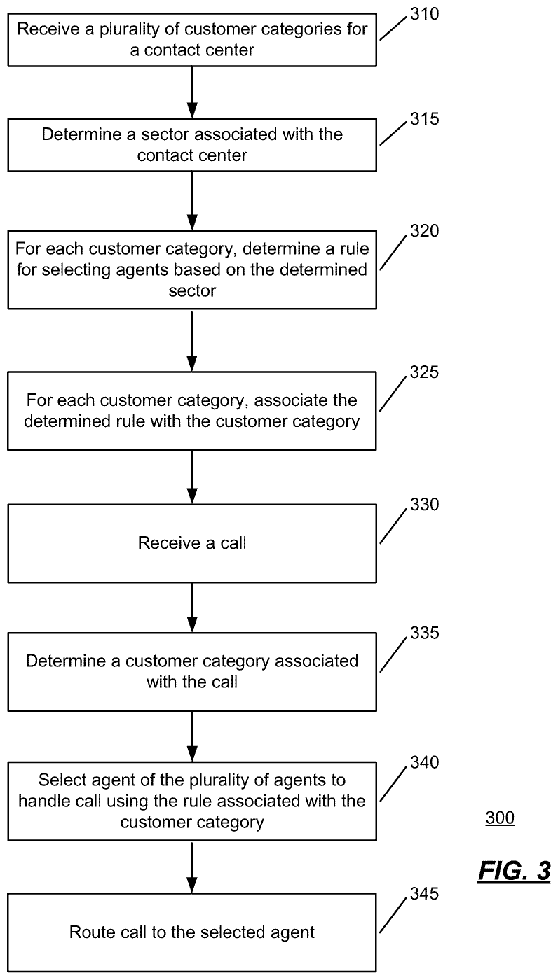

FIG. 3 is an illustration of an example method 300 for determining a rule 225 for a plurality of customer categories for a contact center 150 based on historical performance data 255. The method 300 may be implemented by the agent routing platform 140.

At 310, a plurality of customer categories for a contact center is received. The customer categories may be received by the recommendation engine 240 of the agent routing platform 140. The contact center 150 may be associated with an entity such as a company or corporation.

At 315, a sector associated with the contact center is determined. The sector may be determined by the recommendation engine 240. The sector may be the industry or field associated with the entity that is using the contact center 150 to handle calls.

At 320, for each customer category, a rule for selecting agents based on the determined sector is determined. The rule 225 for selecting agents 120 for a contact center 150 may be determined by the recommendation engine 240. In some implementations, the determination may be a recommendation that is based on historical performance data 255 that was collected about other customer categories 215 and the rules 225 that were used to route calls to agents 120 for those customer categories 215. The historical performance data 255 may be limited to historical performance data 255 that was collected about customer categories 215 of entities that are associated with the same, or similar, sector as the determined sector.

At 325, for each customer category, the determined rule is associated with the customer category. The determined rule 225 may be associated with the customer category 215 by the category engine 220 of the agent routing platform 140.

At 330, a call is received. The call may be received by the routing engine 230 from a customer 110. The customer 110 may have called the contact center 150.

At 335, a customer category associated with the call is determined. The customer category 215 may be determined by the routing engine 230. The customer category may be determined by information associated with the call and/or customer 110 such as country of origin, language spoken, and purpose of call, for example.

At 340, an agent of a plurality of agents is selected to handle the call using the rule associated with the customer category. The agent 120 may be selected by the routing engine 230 using the rule 225 associated with the customer category 215.

At 345, the call is routed to the selected agent. The call may be routed to the agent 120 by the routing engine 230.

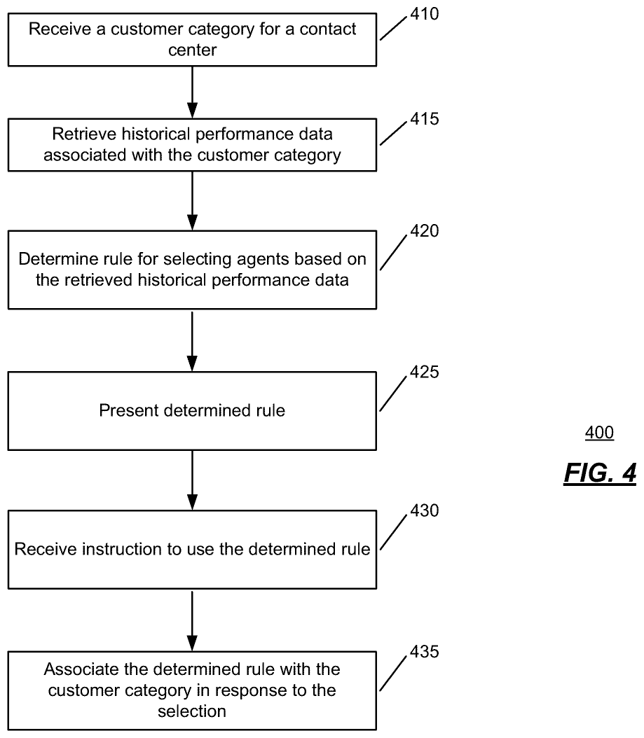

FIG. 4 is an illustration of an example method 400 for determining a rule 225 for a customer category for a contact center based on historical performance data 255. The method 400 may be implemented by the agent routing platform 140.

At 410, a customer category for a contact center is received. The customer category 215 may be received by the recommendation engine 240 through a GUI, for example. The customer category 215 may be provided by an entity that will use the contact center to handle calls for the entity. The entity may be a company or business, for example. The entity may be associated with a particular industry or sector of the economy such as clothing, computer or technology, healthcare, etc.

At 415, historical performance data associated with the customer category is retrieved. The historical performance data 255 may be a collection of performance metrics 245 recorded over time for the received customer category 215. The historical performance data 255 may have been collected from different entities than the entity that provided the customer category 215 through the GUI. The historical performance data 255 may further include the various rules 235 and agents 120 that were used when the various performance metrics 245 were recorded.

At 420, a rule for selecting agents based on the retrieved historical performance data is determined. The rule 235 may be determined by the recommendation engine 240. The recommendation engine 240 may use the historical performance data 255 to select or create a rule 225 that will likely to be successful for the entity with respect to the customer category 215. The rule 225 may be used by the routing engine 230 to select agents 120 to handle calls associated with the customer category 215. Each rule 225 may include a plurality of attributes 235. The recommendation engine 240 may use the historical performance engine 255 to select the attributes 235 that are most associated with performance metrics 245 that satisfy or exceed relayed performance metric thresholds. The recommendation engine 240 may further consider information such as the number of agents 120 that are associated with the contact center 150 and/or the entity.

Depending on the embodiment, the recommendation engine 240 may use the historical performance data 255 to train a model that can predict the performance metrics 245 for rules 225 based on factors such as the attributes 235 associated with the rules 255, the attributes 235 associated with each agent 120, the number of agents 120, and the associated sector. The recommendation engine 230 may then use the model to recommend or determine a rule 225 for the entity.

At 425, the determined rule is presented. The determined rule 225 may be presented to the entity in the GUI.

At 430, an instruction to use the determined rule is received. The instruction may be received by the recommendation engine 240 from the entity through the GUI.

At 435, the determined rule is associated with the customer category. The determined rule 225 may be associated with the customer category 215 by the category engine 220 of the agent routing platform 140.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of tangible computer readable media. Computer readable media can be any available tangible media that can be accessed by device 500 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a plurality of customer categories for a contact center by a computing device;
determining a sector associated with the contact center by the computing device;
for each customer category of the plurality of customer categories, determining a rule for selecting agents of a plurality of agents to handle calls associated with the customer category based on the determined sector by the computing device; and
for each customer category of the plurality of customer categories, associating the determined rule with the customer category.

2. The method of claim 1, further comprising:
receiving a call;
determining a customer category associated with the call;
selecting an agent of the plurality of agents to handle the call using the rule associated with the customer category; and
routing the call to the selected agent.

3. The method of claim 2, wherein the customer category is determined based one or more of a language spoken by a customer associated with the call, a country associated with the customer, and a priority associated with the customer.

4. The method of claim 1, wherein determining the rule for selecting agents of a plurality of agents to handle calls associated with the customer category based on the determined sector comprises:
retrieving historical performance data associated with the sector and customer category; and
determining the rule based on the retrieved historical performance data.

5. The method of claim 1, wherein the rule comprises a plurality of attributes.

6. The method of claim 1, further comprising:
for each customer category of the plurality of customer categories, recommending the determined rule for the customer category;
for each customer category of the plurality of customer categories, receiving an instruction to use the determined rule for the customer category; and
for each customer category of the plurality of customer categories, associating the determined rule with the customer category in response to the received instruction.

7. The method of claim 1, further comprising determining the plurality of customer categories based on the sector.

8. A system comprising:
at least one processor; and
a non-transitory computer readable medium comprising instructions that, when executed by the at least one processor, cause the system to:
receive a plurality of customer categories for a contact center;
determine a sector associated with the contact center;
for each customer category of the plurality of customer categories, determine a rule for selecting agents of a plurality of agents to handle calls associated with the customer category based on the determined sector; and
for each customer category of the plurality of customer categories, associate the determined rule with the customer category.

9. The system of claim 8, further comprising instructions that, when executed by the at least one processor, cause the system to:
receive a call;
determine a customer category associated with the call;
select an agent of the plurality of agents to handle the call using the rule associated with the customer category; and
route the call to the selected agent.

10. The system of claim 9, wherein the customer category is determined based one or more of a language spoken by a customer associated with the call, a country associated with the customer, and a priority associated with the customer.

11. The system of claim 8, wherein determining the rule for selecting agents of a plurality of agents to handle calls associated with the customer category based on the determined sector comprises:
retrieving historical performance data associated with the sector and customer category; and
determining the rule based on the retrieved historical performance data.

12. The system of claim 8, wherein the rule comprises a plurality of attributes.

13. The system of claim 8, further comprising instructions that, when executed by the at least one processor, cause the system to:
for each customer category of the plurality of customer categories, recommend the determined rule for the customer category;
for each customer category of the plurality of customer categories, receive an instruction to use the determined rule for the customer category; and
for each customer category of the plurality of customer categories, associate the determined rule with the customer category in response to the received instruction.

14. The system of claim 8, further comprising determining the plurality of customer categories based on the sector.

15. A non-transitory computer-readable medium comprising instructions that, when executed by at least one processor, cause a computer system to:
receive a plurality of customer categories for a contact center;
determine a sector associated with the contact center;
for each customer category of the plurality of customer categories, determine a rule for selecting agents of a plurality of agents to handle calls associated with the customer category based on the determined sector; and
for each customer category of the plurality of customer categories, associate the determined rule with the customer category.

16. The computer-readable medium of claim 15, further comprising instructions that, when executed by the at least one processor, cause the computer system to:
receive a call;
determine a customer category associated with the call;
select an agent of the plurality of agents to handle the call using the rule associated with the customer category; and
route the call to the selected agent.

17. The computer-readable medium of claim 16, wherein the customer category is determined based one or more of a language spoken by a customer associated with the call, a country associated with the customer, and a priority associated with the customer.

18. The computer-readable medium of claim 15, wherein determining the rule for selecting agents of a plurality of agents to handle calls associated with the customer category based on the determined sector comprises:
retrieving historical performance data associated with the sector and customer category; and
determining the rule based on the retrieved historical performance data.

19. The computer-readable medium of claim 15, wherein the rule comprises a plurality of attributes.

20. The computer-readable medium of claim 15, further comprising:
for each customer category of the plurality of customer categories, recommending the determined rule for the customer category;
for each customer category of the plurality of customer categories, receiving an instruction to use the determined rule for the customer category; and
for each customer category of the plurality of customer categories, associating the determined rule with the customer category in response to the received instruction.
